(19) United States
(12) Patent Application Publication
(10) Pub. No.: US 2024/0153029 A1
(43) Pub. Date: May 9, 2024

(54) Connect and Thrive Couples Workshop

(71) Applicant: Liz Wee, Torrance, CA (US)

(72) Inventor: Liz Wee, Torrance, CA (US)

(21) Appl. No.: 17/982,050

(22) Filed: Nov. 7, 2022

(51) Int. Cl. G06Q 90/00

(52) U.S. Cl. CPC G06Q 90/00

(57) ABSTRACT

Systems and methods are disclosed herein for completely advance approach of organizing workshops with multiple modules allowing people to meet, interact and develop understanding with each other. The system in addition to its flexible programs also allows multiple structured activities including but not limited to role playing, art making process, dance movement (especially Tango), get to know each other activities, and lectures and discussions. The proposed system is physical system to maximize the effect of the workshop, but it also may be modified for online format in the future.

### BACKGROUND

### Field of the Invention

Embodiments relate to the field of communications and, more particularly, to a system and a method for providing methods and systems that requires connecting two individuals for the purpose of building connection and intimacy with each other through a workshop comprising of multiple activities between participants including but not limited to interactive lectures, group discussions and sharing, role plays, art making, and dance movements.

### DESCRIPTION OF THE RELATED ART

Being in a relationship takes hard work. The complexity of how people interact has dramatically increased in today's world. And many couples experience challenges as you learn to live together in a world full of distractions and complications.

The most common issues couples experience in a committed monogamous relationships are, unhealthy or ineffective communications, explosive or escalated arguments and fights, loss/lack of connection/intimacy, declined sexual desire for each other, lack of or minimal physical or verbal affection, and betrayal of trust. These challenges can be addressed in Connect and Thrive Couples workshop with the help of trained professionals.

There are multiple inventions that have been proposed in prior art regarding positive relationship development among couples. For instance, a relationship workshop and couples therapy can both help couples identify existing problems and struggles, learn new tools to build a new interaction that is healthy and positive, and process the feelings between the partners about the current and past hurt/difficulties. Couples therapy can assist partners (re)create safety, (re)build trust, and (re)foster connection and intimacy between the partners over a period of a few months or a few years. It is an open-ended process that allows the therapist to adapt specifically to couples' needs and in return the couples can explore the issues in a deeper level. A couple's workshop can achieve the same goals but it is designed to jump start the process in a matter of a few days, for the couples who cannot financially afford weekly couples therapy sessions in a privacy of a therapist's office.

In a workshop experience, you get to witness other couples' interactions and journeys and learn from each other. The group setting also provides the universality among the participants, reminding them that they are not alone, when it comes to navigating through the difficulties in their relationships. The structured exercises are intensive and thorough; therefore, it promotes a faster breakthrough.

The proposed system provides a workshop for couples, who want to learn how to connect with each other in a deeper level and in a meaningful way. The workshop will utilize multidimensional methods, such as guided meditations, soundbaths, role plays, lectures, discussions, and communication skill trainings and intimacy building exercises, utilizing Tango dance movements and art making process. The participants will be able to enhance their relationships by building better communication skills, increasing connection and intimacy, and healing painful relationship patterns. The participants will also gain insight into self, each other, and their relationship.

None of the previous inventions and patents, taken either singularly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a workshop management comprising of set of activities to provide better communication and understanding among couples.

It is also the objective of the invention to provide an advance approach utilizing multidimensional methods, such as guided meditations, soundbaths, role plays, lectures, discussions, and communication skill trainings and intimacy building exercises, utilizing Tango dance movements and art making process.

It is further the objective of invention to allow to communicate with number of approaches to make it possible to create a dynamic, reliable, and holistic model for a similar platform.

It is further the objective of the invention to provide a workshop that will be conducted in one or multiples weekends (workshops) or in five to seven consecutive days (retreats). They are suitable for all dyadic couples, who are in a committed long-term relationship, regardless their sexual orientations.

It is further the objective of the invention to provide a system which brings ease of use, interest development and convenience for the user.

It is moreover the objective of the invention to provide a system that is of a durable and reliable approach toward understanding development process and to help couples connect/reconnect emotionally, physically, and sexually.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Traditional couples talk therapy or couples' workshop do not utilize multidimensional approach. Verbal expression of emotion is extremely important but it can only access so much of our emotion.

The current invention in its preferred embodiment discloses an advance system allowing using advanced concepts and techniques to create a functionality similar to a normal physical meeting experience. Leveraging the principles of Intelligence, the system employs multiple enhanced features allowing maximum efficiency and support to users and to help couples connect/reconnect emotionally, physically, and sexually.

The present disclosure is directed to an improved connection and understanding method and system that addresses the issues observed in existing services and provides workshop-based approach to facilitate the individuals.

The present approach as per its further embodiments is suitable for all dyadic couples, who are in a committed long-term relationship, regardless their sexual orientation. The participants will be able to enhance their relationships by building better communication skills, increasing connection and intimacy, and healing painful relationship patterns. The participants will also gain insight into self, each other, and their relationship.

The proposed method allows to maintain/improve the relationships among individuals. Through this approach, couples will learn new skills to communicate more effectively, to build and nurture intimacy and to manage difficult conflicts. The current plan is to facilitate the workshop over 2 days which can evolve into an extended workshop that is 5 days long, paired with a couple retreat. It also will be used as research projects and books. A method to apply to traditional couples talk therapy sessions will be created based on this workshop.

The method incorporates art therapy methods and Tango dance movement to create intimacy and connection among couples. It allows to access hidden emotions inside us, and heighten desired emotions within ourselves. Art making process helps us tap into our subconsciousness and helps us express ourselves creatively. Learning basic Tango movements will teach partners to be attuned to each other, how to physically and emotionally connect, how to lead and follow, and finally utilize dancing as a shared activity to create a healthy and thriving relationship.

The method as per its further embodiments provides following plan in two days' workshop.

### Day 1: Meet at 10 am

Greetings. Participants introduce themselves to everyone in the group and their goals for the workshop.
Introduction of the facilitator and the vision of the workshop.
A soundbath.
Lecture on attachment theory and discussion.

### Lunch at 12:30 pm

Lecture on effective communication skills.
Activities and role play between the partners of positive and effective communication.
Art processing & share.

### 15 min Break 3:30 pm

Lecture on benefits of dance movement for mental and physical health
Tango movement exercises to foster attunement and connection between partners.
Discussion
Closing ritual 5 pm

### Day 2:10 am

Guided meditation
Quick art check-in and share.
Tango movement exercises to overcome power struggles and to foster trust.
Lunch at 12:30 pm
Discussion
Activities and role play between partners for creating and promoting intimacy and connection.

### 15 min Break 3:30 pm

Art activity & share.
Lecture on healthy sex
Discussion
Closing ritual 5 pm

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: A physical workshop method based on idea of connecting/reconnecting two individuals, comprising:
an indication from a first user, the indication being indicative of interest of the first user in connecting with a second user;
receiving, an indication from a second user the indication being indicative of interest of the second user in connecting with the first user; and,
generating multiple programs in a workshop to practice and enhance learning on relationship making.

2: A system for connection and integration among individuals comprising a workshop for couples, who want to learn how to connect with each other. The workshop will utilize multidimensional methods, such as guided meditations, soundbaths, role plays, lectures, discussions, and communication skill trainings and intimacy building exercises, utilizing Tango dance movements and art making process to create harmony and understanding among individuals.
